(19) United States
(12) Patent Application Publication
(10) Pub. No.: US 2007/0158601 A1
(43) Pub. Date: Jul. 12, 2007

(54) Rod Type Mechanical Valve for Fluid Flow Control

(75) Inventors: George D. Mitchell, Cloudcroft, NM (US); Rodney D. Anderson, Prescott, NM (US)

Correspondence Address: STEVE BERTONE;KIRKPATRICK & LOCKHART PRESTON GATES ELLIS LLP, 618 WEST RIVERSIDE AVENUE, SUITE 300, SPOKANE, WA, 99201-0628, US

(73) Assignee: CarterOne, LLC Organized in: State of Nevada, Prescott, AZ (US)

(21) Appl. No.: 11/621,930

(22) Filed: Jan. 10, 2007

Related U.S. Application Data
(60) Provisional application No. 60/757,391, filed on Jan. 10, 2006.

(51) Int. Cl. F16K 7/04

(52) U.S. Cl. 251/5

(57) ABSTRACT

A rod and orifice mechanical fluid flow control valve for controlling fluid flow between two or more fluid pressure areas. In another aspect, a rod and orifice mechanical fluid flow control valve for controlling or restricting the motion of two fluid pressure areas or physical structures. A motion restricting embodiment is described in detail, namely an automotive shock absorber. In another aspect, the rod in a rod and orifice mechanical fluid flow control valve is adjustable and configurable for a given application. In yet another aspect, the cross section of the rod in a rod and orifice mechanical fluid flow control valve is of a rectangular shape.

### CROSS REFERENCE TO RELATED APPLICATIONS

This application claims the benefit of U.S. Provisional Application No. 60/757,391, filed Jan. 10, 2006, titled “Rod type mechanical valve for fluid control” and whose entire contents are hereby incorporated by reference.

### TECHNICAL FIELD

The present invention pertains to rod and orifice type mechanical valve for fluid flow control. In one family of embodiments, the fluid flow control of the valve serves to manipulate or restrict the pressure differential between two separate fluid pressure areas, which can be used to control the spatial positioning or dynamic motion between two physical objects, (e.g. a shock absorber). In a wholly different family of embodiments, the spatial positioning of two physical objects or the pressure differential between two fluid pressure areas, by virtue of the valve, can be used to control a fluid flow, (e.g. an automatic irrigation valve).

### BACKGROUND

Mechanical, automatic pressure regulating valves used in fluid systems are generally constructed in such a manner as to have an opening or orifice through which fluid is intended to flow in some specific direction. Typically, such valves have an input side and an output side, as the fluid flow is designed to be one-directional. A valve gate, which could also be in the form of a plug, cover or other obstruction, is usually located proximate to the orifice and is used to restrict or regulate the flow of fluid by covering or plugging the orifice. In this fashion, the flow of fluid through the valve can be automatically restricted or regulated by the gate obstructing the orifice.

For many automatic mechanical pressure regulating valves, varying the effective orifice opening size and fluid flow is accomplished by allowing pressure on the valve's input side to act against the gate in such a manner as to force the gate away from the valve orifice when an increase in input pressure is experienced. This increase in effective orifice size thereby allows the fluid flow through the valve. Conversely, allowing the gate to move closer to the valve orifice when a relative decrease in pressure on the input side causes a reduction or abatement of fluid flow due to the reduction of the effective orifice opening size.

These pressure, flow and automatic functions of a typical mechanical fluid flow control valve are usually accomplished by applying a calibrated mechanical spring (or other one-way pressure mechanism) to the gate in such a manner as to force the gate toward the closed position. When sufficient pressure is applied to the gate on the input side of the valve, the gate moves farther away from the orifice, thereby creating a less restricted flow of fluid through the valve. The valve's open position is thus maintained so long as the pressure applied to the valve's input side remains higher than the force exerted by the mechanical spring in the opposite direction. This type of valve is frequently called a “clapper” valve.

Unfortunately, clapper valves and other mechanical gate valves are restricted to a limited range of operations and normally attempt to control differential pressure at some specific preset value. When these systems are preset to some specific pressure and fluid flow rate range where they achieve best performance, they fail to properly control fluid pressure over a broader range of pressures or flow rates.

Despite such limitations, shock absorbers, struts and other motion resistance devices of the present art typically utilize such clapper valves to perform their function. As such, these motion restriction devices also inherit the shortcomings of their basic component, the clapper valve, and translate to an inability to perform consistently and reliably over a broad range of pressures, flow rates and environmental conditions.

An example of this failure to perform is noted in ground vehicle wheel shock absorbers where axle springs or gas bag suspension systems are involved. The internal clapper valves in these shock absorbers are set for a narrow specific pressure range where the average driving conditions occur. These devices are thus found lacking when a pothole or large bump is encountered on the traveling surface that causes wheel acceleration rates and thus shock absorber internal pressures and fluid flow rates to be excessively high, which in turn causes extreme activation or failure of the vehicle's suspension system if the shock absorber does not perform properly.

Due to the extreme dynamic motion demands placed on shock absorbers and other motion restriction devices, shock absorbers based on clapper valve technologies exhibit a substantial amount of heat generation. This generation of heat, in turn, exacerbates and adversely affects the shock absorber's ability to perform consistently and reliably in its function of restricting the dynamic motion between two physical structures, such as a vehicle's frame and its axle.

To digress, a vast majority of the heat generated by a traditional shock absorber or motion restriction device typically stems from the absorption of energy by the shock absorber required to resist or oppose the forces and motion asserted by the axle against the frame of the vehicle. This energy, by virtue of the restriction of the fluid flow, is transformed into a form of heat.

In a traditional shock absorber, a clapper valve can only perform within a narrow range of pressures and flow rates, and the resistance is not configurable or adjustable across the stroke of the shock absorber. Therefore, to accommodate the potential for extreme suspension demands, (e.g. a pothole or large bump), the shock absorber necessarily needs this resistance to be sufficient to prevent the axle's forces and motion from reaching the extreme positions of the suspension system. Since a clapper valve is substantially constant in its resistance across the entire stroke of the shock absorber, a vehicle experiences the same resistance at the center positions of the shock absorber as it does at the ends of the shock absorber. This is not necessarily desirable, in terms of performance, as it places unnecessary motion restriction on the vehicle suspension system in the center of its stroke.

Optimally, a shock absorber or motion device would assert little or no resistance in the middle of the stroke of the suspension, while aggressively increasing the resistance as the axle reaches the extreme end of the stroke of the suspension. Such a shock absorber would provide superior performance, as it would provide a soft ride in the center of the suspension with the protection of preventing extreme suspension travel, (e.g. bottoming-out or topping-out the suspension due to a pothole or large bump, respectively). There are several manufacturers of expensive racing shock absorbers, (e.g. Fox, King), that utilize a complicated array of hoses and extra tanks to accommodate this non-linear motion resistance profile. However, such shock absorbers are not very adjustable, and further continue to generate heat causing adverse performance conditions.

Another solution in the area of mechanical fluid flow control valves, while uncommon, is to implement a rod and orifice style valve. While rod and orifice mechanical valves have been available in specific applications, such as aircraft wheel struts, this technology has not yet been developed to its potential by automotive, aviation and other industries, as this technology poses significant challenges in design and manufacture. Moreover, prior art valves are extremely difficult to precisely adjust or alter in order to change the relationship between the rod, orifice, and opening, without adversely affecting the durability of the motion restriction device.

Given the above problems caused by clapper valves and other traditional mechanical fluid flow control valves, new technologies and advancements in rod and orifice mechanical fluid flow control valves are badly needed. It would be highly advantageous to the automotive industry and other industries to design and manufacture such a fluid flow control valve that operates within a broad range of pressures, a broad range of dynamic motion and a broad range of environmental conditions.

Such an application of a rod and orifice valve would be highly beneficial if it provided a method to configure a specific and programmed response to a specific set of pressures and motions. For example, an automotive shock absorber that was configured with a rod and orifice mechanical fluid flow control valve that had reduced resistance in the center of its stroke would be highly advantageous. Such a shock absorber would translate into a shock absorber attaining better mileage, better tire wear and better ride for the vehicle.

While automotive and aviation applications present an exemplary case in point to demonstrate the need for a better solution, this need is felt on a broader level for many mechanical fluid flow valve applications requiring consistent, reliable control of fluid flow in various load, motion and environmental conditions.

### SUMMARY

Embodiments of the present invention are directed to an improved mechanical fluid flow control valve implementing a rod and orifice. More particularly, the valve orifice is situated between two or more pressure areas in a fluid system.

In a preferred embodiment of the present invention, the rod and orifice mechanical fluid flow control valve is utilized in a motion restriction device, namely an automotive shock absorber. Such an embodiment typically exhibits desirable performance, adjustability, consistency or reliability over traditional shock absorbers that utilize a traditional clapper valve.

According to one aspect of the invention, a motion restriction device having a piston and a cylinder utilizes a rod and orifice valve to control the flow of fluid between two or more pressure areas to control acceleration between the piston and the cylinder. More particularly, the rod can be configured with a custom shape adapted to the specific application, thereby creating an intended response of the motion restriction device to various dynamic motions between the piston and the cylinder. By way of example, a concave shape of the rod provides minimal motion restriction when the middle of the rod is in the orifice, while providing substantially increasingly aggressive motion restriction when one of the ends of the rod are in the orifice.

According to another aspect of the invention, embodiments can also be used to control recoil on a gun or other artillery device. In such an application, the amount of recoil energy is dependent on the explosive charge used to propel the projectile selected. Embodiments of the present invention can permit the response and stiffness of the recoil to be quickly adjusted to fit each situation, thereby preventing undesirable recoil that could affect the correct aiming of the following round.

Various options and approaches of embodiments of the invention are also discussed throughout the technical disclosure, including additional components, characteristics and aspects that enhance the performance of various embodiments. By way of example, according to another aspect of the invention, it is possible to configure such a mechanical fluid flow control valve to be disassembled and adjustable, given modest modifications to the basic design.

According to yet another aspect of the invention, the rod utilized in the mechanical fluid flow control valve possesses a rectangular cross section. Such a rod is easily and highly adjustable, as the rectangular shape can be easily modified with standard workshop tools.

In yet an additional aspect of the invention and family of embodiments, relative motion or pressure differentials between two pressure areas can also be used to control the flow of fluid through such a mechanical valve. Such embodiments would be particularly useful to the areas of automatic shut-off or automatic flow control valves used in irrigation, plumbing or other fluid applications.

It is understood that while automotive motion restriction devices are exemplary applications used to describe specific details of a best mode of practice of the invention, the presently disclosed invention also contemplates other devices utilizing a rod and orifice style mechanical fluid flow control valve disclosed herein.

### BRIEF DESCRIPTION OF THE DRAWINGS

Embodiments of the invention are illustrated by way of example, and not by way of limitation, in the figures of the accompanying drawings and in which like reference numerals refer to similar elements, wherein:

FIG. 1 is a cut-away side view illustrating a motion restriction device in a standard configuration according to an embodiment of the invention;

FIG. 2 is a cut-away side view illustrating a motion restriction device in an extended configuration according to an embodiment of the invention;

FIG. 3 is a cut-away side view illustrating a motion restriction device in a compressed configuration according to an embodiment of the invention; and,

FIG. 4 is a cut-away side view illustrating an adjustable motion restriction device in a standard configuration according to an embodiment of the invention.

FIG. 5 is a cut-away top view illustrating an adjustable motion restriction device, and more particularly a partial top view downward at the cross section located at the valve wall containment flange.

FIG. 6 is a cut-away top view illustrating an adjustable motion restriction device, and more particularly a partial top view downward at the cross section located at the valve wall.

FIG. 7 is a cut-away side view illustrating a motion restriction device in a standard configuration according to an embodiment of the invention.

### DETAILED DESCRIPTION OF PREFERRED EMBODIMENTS

In the following description, for the purposes of explanation, specific details are set forth in order to provide a thorough understanding of the invention. However, it will be apparent that the invention may be practiced without these specific details. In other instances, well-known structures and devices may be depicted in block diagram form in order to avoid unnecessary obscuring of the invention. Section titles and references appearing within the following paragraphs are intended for the convenience of the reader and should not be interpreted to restrict the scope of the information presented at any given location.

Various aspects and features of example embodiments of the invention are described in more detail hereinafter in the following sections: (i) Functional Overview, (ii) Preferred Embodiments, (iii) Examples, (iv) Additional Embodiments and (v) Conclusion.

### Functional Overview

The new and novel mechanical fluid flow control valve disclosed in the present technical disclosure solves a variety of the aforementioned shortcomings and problems posed by the present art of mechanical valves.

More particularly, problems that exist in the operating limitations of mechanical clapper-type spring-loaded valves are alleviated by a rod that passes through a calibrated orifice to create a mechanical fluid flow control valve that is controlled by the relative position of the rod with respect to the orifice.

At the basic levels of theory, embodiments of the invention primarily consist of a solid plane that separates two different pressure areas, with the solid plane having a void or orifice through which fluid or a gas can pass. A custom shaped rod or rod-like member of a desired length remains slidably configured within the orifice. The combination of the orifice and rod, and the effective opening thereof between them, forms a variable fluid valve between two fluid pressure areas. Given a desired shape and size of the orifice, working in combination with a desired shape and size of the rod, the flow of fluid or gas between the two applicable pressure areas can be controlled.

By attaching the solid wall defining the orifice to the control surfaces of one pressure area, and likewise attaching the rod to the control surfaces of the other pressure area, with the rod still inserted through the orifice, then any proximity movement between the two pressure areas will immediately adjust the position of the rod within the orifice, and thereby alter the effective orifice opening based on the profile of the rod. At any location along the length of the rod, the shape and cross-section of the rod thereby determines the specific response at the instant that section of the rod member is passing through the orifice.

The response, as dictated by the profile of the rod, can be arbitrarily linear or non-linear as required to maximize the utility of the valve for its designed use. Thus, automatic, custom control of fluid flow between two effected pressure areas, as in the above scenario, is achieved based primarily on the relative positions of the two areas and not solely on fluid pressure, as in other mechanical valve designs such as the clapper valve.

When used in a hydraulic system such as a ground vehicle wheel shock absorber having two differentially movable fluid pressure areas with a separating orifice, the control of fluid flow between the two chambers is achieved by the custom design of the orifice and rod combination, not solely on the differential of the pressures in the fluid pressure areas.

By operating in this manner, the acceleration and deceleration rates between two or more fluid pressure areas of a fluid system can be held constant or varied as desired, thereby also controlling the corresponding acceleration and deceleration rates of the surfaces/structures containing the fluid pressure areas.

Alternatively, the relative positioning or pressure differentials between two fluid pressure areas can be used to control the flow of fluid through the mechanical fluid flow control valve. Thus, in one form of embodiments of the present invention, the mechanical fluid valve can be used to control motion of two fluid pressure areas, and in another form of embodiments can be used to control the flow of fluid given the relative position, motion or pressure differential between two fluid pressure areas.

### Preferred Embodiments

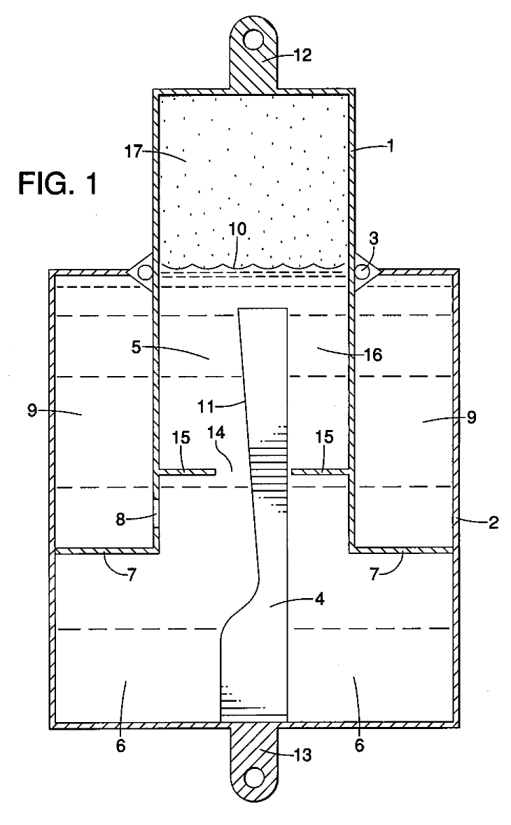

As can be appreciated by the various figures presented in the technical disclosure herein, embodiments of the present invention can be made and used with relatively few mechanical components. FIGS. 1 through 3 illustrate a basic embodiment of the present invention.

Turning first to FIG. 1, a cut away view of an embodiment of the present invention is shown. More particularly, the figure illustrates a rod and orifice style mechanical fluid control valve embodied in a motion resistance device such as a shock absorber or strut. The view of the device is cut lengthwise top to bottom through the vertical centerline of the illustration. As indicated by the reference numbers, the embodiment shown can be constructed and used given a modest list of components and characteristics, namely: a piston 1, a cylinder 2, a cylinder fluid seal 3, a rod 4, a piston area 5, a lower cylinder area 6, a piston footing 7, a fluid passage 8, an upper cylinder area 9, a fluid level 10, a custom shape 11, a piston attachment means 12, a cylinder attachment means 13, a valve orifice 14, a valve wall 15, a fluid 16 and a gas 17. While the above list encompasses a suggested list of components and characteristics for the illustrated embodiment, embodiments of the invention do not necessarily require that every component or characteristic listed above be present in any given embodiment in order to practice the presently disclosed invention.

Now particularly discussing the individual components and characteristics of such an embodiment, a piston 1 typically comprises a tubular piston of a predetermined wall thickness and length, closed on one end and open on the other end. The basic structure of piston 1 can also be described as being a substantially hollow cylinder with one closed end and one open end. In preferred embodiments such as those various embodiments disclosed herein, piston 1 is illustrated and described as being of uniform diameter, such that the cross section of the piston is circular. However, alternate embodiments of the present invention can be manufactured with a piston 1 not having a uniform diameter, such as the cross section of a piston 1 having an oval, rectangular or other desired shape.

A cylinder 2 is typically comprised of a tubular cylinder of a predetermined wall thickness and length, having one closed end and one open end. Again, in preferred embodiments such as those various embodiments disclosed herein, the cylinder 2 is illustrated and described as being of uniform diameter, such that a cross section of the cylinder 2 is circular. However, alternate embodiments of the present invention can be manufactured from a cylinder 2 not having a uniform diameter, such as a cylinder 2 having a cross section of an oval, rectangular or other desired shape.

A valve wall 15 substantially containing the open end of piston 1 is typically configured upon piston 1. A valve orifice 14 is defined by a void in the valve wall 15, thereby configured to provide an opening at the open end of piston 1.

Piston 1 is axially and concentrically slidably mounted within cylinder 2. More particularly, the open end of piston 1 slidably engages into cylinder 2 through the open end of cylinder 2. As depicted in FIG. 1, in preferred embodiments piston 1 and cylinder 2 are configured and oriented relative to each other in such a manner that piston 1 is typically higher in elevation than cylinder 2 when no fluid-air separator is employed in the system. If a fluid-air separator is employed or other equivalents in function are provided, then embodiments of the present invention can be practiced with any relative elevation of piston 1 with respect to cylinder 2.

Piston 1, including the valve wall 15, also serves to define a piston area 5 that is substantially contained and formed by inner surfaces of piston 1 and the inner surfaces of valve wall 15.

Likewise, the inner surfaces of cylinder 2 also define a volume, comprised of a lower cylinder area 6 and an upper cylinder area 9. As illustrated in FIG. 1, the position of piston 1 within cylinder 2 defines the respective sizes of lower cylinder area 6 and upper cylinder area 9 in comparison to the total volume defined by cylinder 2. More particularly, lower cylinder area 6 is defined substantially by inner surfaces of cylinder 2 in conjunction with the bottom surfaces of piston 1, namely the piston footing 7, if configured, and the valve wall 15, if configured. Accordingly, upper cylinder area 9 is substantially defined by inner surfaces of cylinder 2, outer surfaces of piston 1 and the upper surface of the piston footing 7, if configured. Where a piston footing 7 is not configured in an embodiment of the invention, the upper cylinder area 9 and lower cylinder area 6 would be a single environmental space, thereby comprising a pressure area that is best characterized as a lower cylinder area 6.

In preferred embodiments of the present invention, a fluid 16 is contained within cylinder 2, namely within the lower cylinder area 6 and the upper cylinder area 9. Typically, a fluid passage 8 provides for environmental communication and flow of a fluid 16 between the lower cylinder area 6 and upper cylinder area 9. Such a flow of fluid 16 thereby relieves pressure differentials between the lower cylinder area 6 and upper cylinder area 9 that may be experienced as piston 1 slidably moves in or out of cylinder 2.

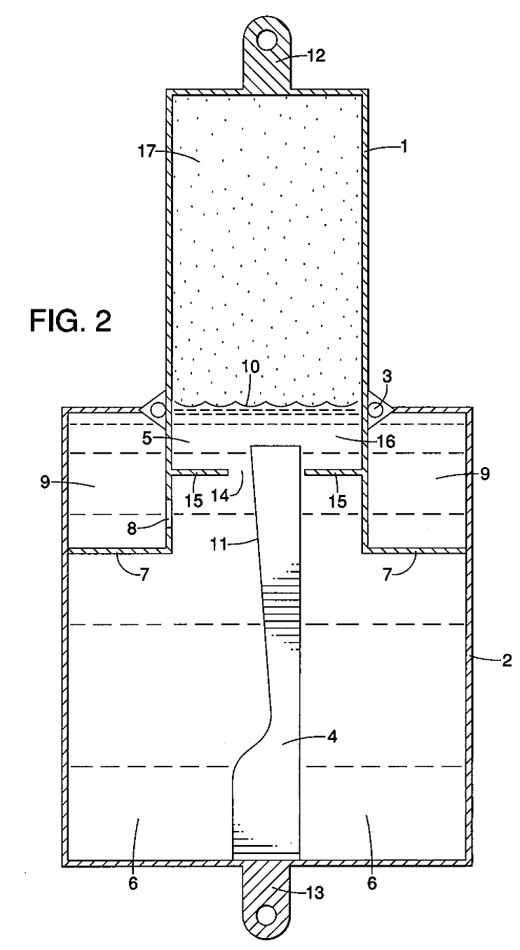

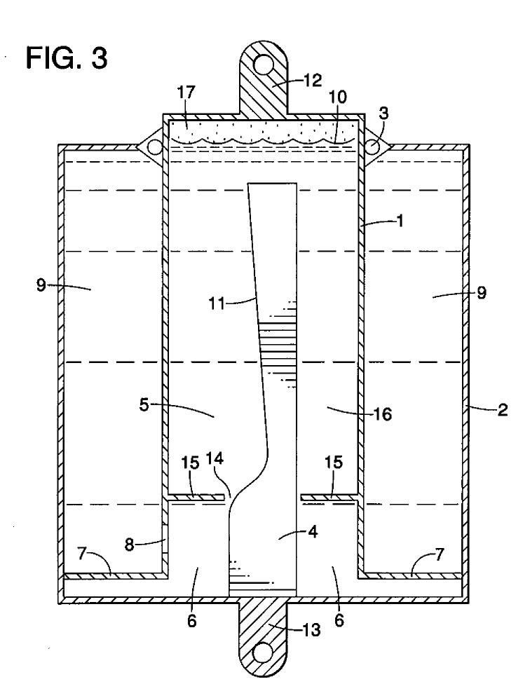

As can be appreciated by a brief review of FIG. 2, as piston 1 is extended and pulled away from its engagement with cylinder 2, known as an extension stroke, the upper cylinder area 9 decreases in volume as the lower cylinder area 6 increases in volume. Conversely, as can be appreciated by a brief review of FIG. 3, as piston 1 is moved farther into cylinder 2, known as a compression stroke, the upper cylinder area 9 increases in volume as the lower cylinder area 6 decreases in volume.

Returning to FIG. 1, by virtue of the engagement of piston 1 slidably engaged into cylinder 2 and the configuration of a valve orifice 14 or other opening at the open end of piston 1, piston area 5 is in environmental communication with lower cylinder area 6 and upper cylinder area 9, thereby providing for the desirable flow of fluid 16 between piston area 5, lower cylinder area 6 and upper cylinder area 9.

Prior to operation, fluid 16 of any desired liquid or gaseous material is inserted into cylinder 2 and piston 1 until a desired fluid level 10 is attained. Typically, but not essentially, such a fluid level 10 is located above valve orifice 14.

In preferred embodiments, a gas 17 occupies any remaining volume of piston area 5 not otherwise occupied by fluid 16. While it is not desirable that gas 17 leak into or otherwise fill any portion of the volume of upper cylinder area 9, it is conceivable that such a condition can occur through turbulent physical activity of the piston 1 and cylinder 2. In alternate embodiments, gas 17 is not necessary to be present in the embodiment of the invention.

In preferred embodiments, a flexible cylinder fluid seal 3 is configured across the open end of cylinder 2 that engages the outer surface of piston 1, thereby allowing piston 1 to move freely in and out axially and concentrically with cylinder 2 without fluid 16 or gas 17 leakage between piston 1 and cylinder 2 at the point of engagement of the fluid seal 3.

A rod 4 extends through the valve orifice 14 into piston area 5. Rod 4 is of a desired length and thickness and suitable material, (such as metal, plastic or composite), attached at one end to the lower end of cylinder 2. The substantially longitudinal contour of at least one surface of rod 4 is typically configured in such a manner to have a variable cross section along different sections of the stroke. It is noted that the cross section of the rod 4 can be of any shape, such as a circle, oval, rectangular or other shape. The substantially longitudinal contour having a variable cross section of rod 4 is illustrated in the figures as a custom shape 11, thereby providing a variably sized effective opening in valve orifice 14 for the flow of fluid 16. In the figures, such a cross section of the rod 4 is of rectangular shape, provided for ease of design, manufacture and modification.

More particularly, rod 4 with its custom shape 11 provides a hydraulic valve operation between piston area 5 and lower cylinder area 6 by passing through valve orifice 14. Rod 4 and valve orifice 14, together, establish a variable fluid opening that is dependent upon the relative positions of rod 4 and valve orifice 14, corresponding to the relative positions of piston 1 and cylinder 2.

As contrasted by the figures in FIGS. 1 through 3, the effective opening of the valve orifice 14 changes with respect to the position of the piston 1 in relation to the rod 4. As shown in FIG. 1, the valve orifice 14 is substantially open, indicating a substantially free flow of fluid between piston area 5 and lower cylinder area 6. This illustrates a normal position for an automotive shock absorber neither experiencing an extension nor compression stroke. However, as shown in FIG. 3 in comparison to FIG. 1, the rod 4 is substantially contained within piston 1 near the end of a compression stroke position. In this figure, due to the custom shape 11 (e.g. larger cross section) of the rod 4 at a position adjacent to the valve wall 15, the valve orifice 14 is substantially obstructed by the rod 4. Likewise by comparison, in FIG. 2 the rod 4 is substantially outside the piston 1 and the custom shape 11 of the rod 4 is of only a moderate size cross section near the end of an extension stroke position. Therefore, the opening of valve orifice 14 illustrated in FIG. 2 is more restrictive than the opening of valve orifice 14 illustrated in FIG. 1, but the opening of valve orifice 14 illustrated in FIG. 3 is even more restrictive than both of the valve orifice 14 openings shown both FIGS. 1 and 2.

While preferred embodiments of the present invention utilize a desired custom shape 11 that is specific to a given application, it is also anticipated that such a custom shape 11 can also be of a consistent diameter along the entire longitudinal axis of the rod 4. Aggressive changes in the diameters of the rod 4 can be implemented in the custom shape 11 to effect dramatic changes in the effective opening of valve orifice 14 and flow of fluid 16. For example, in automotive or aviation applications for motion restriction devices such as shock absorber products, it is preferable that the custom shape 11 of the rod 4 have an increasingly larger diameter at the opposite ends of the rod 4, and a gentle concave shape in the middle of rod 4 between its opposite ends. Such a profile of custom shape 11 provides for the rather unobstructed free flow of fluid 16 through the valve orifice 14 in the middle of the rod 4, with a more restrictive flow of fluid 16 at the ends of rod 4.

Returning once again to FIG. 1, a piston footing 7 is typically attached to the lower end of piston 1 thereby providing a communication between the inner surface of cylinder 2 and the outer surface of piston 1. In various embodiments of the present invention, this communication can be configured to resist leakage, (thereby not allowing significant leakage of fluid around the communication), or the communication can be rather loose, (thereby allowing fluid to pass through or around the communication).

Piston attachment means 12 and cylinder attachment means 13 function as connecting points to other apparatus or the environment. For example, in the motion restriction device embodiment illustrated in FIGS. 1 through 3, the piston attachment means 12 can be connected to the frame of a vehicle with a bolt or other hardware, and cylinder attachment means 13 can be connected to the axle of the vehicle with a bolt or other hardware. The piston attachment means 12 and cylinder attachment means 13 can take the form of a variety of attachment means other than the means illustrated in FIGS. 1 through 3, such as a threaded attachment, a quick disconnect attachment, friction/pressure attachments, welds, adhesives or other means of connections known to those skilled in the mechanical arts.

Turning to FIG. 2, we begin with piston 1 near the end of an extension stroke, practically in the fully extended position, away from cylinder 2. When an upward accelerating force is applied to cylinder 2 relative to piston 1, commonly called a compression stroke, the fluid 16 in lower cylinder area 6 will experience a hydraulic pressure greater than piston area 5 and upper cylinder area 9. When significant fluid pressure differential exists, such as the result of a change in proximity between cylinder 2 and piston 1, fluid 16 will flow into upper cylinder area 9 from lower cylinder area 6 through fluid passage 8. Simultaneously, the opening between rod 4 and valve orifice 14 allows fluid 16 to flow from lower cylinder area 6 into piston area 5, causing a decrease in pressure in lower cylinder area 6, and thereby relieving the pressure differentials between lower cylinder area 6, upper cylinder area 9 and piston area 5.

As also depicted in FIG. 2, rod 4 is of some desired contour or profile, as illustrated in the curved edge of custom shape 11, so as to cause the opening between valve orifice 14 and rod 4 to vary in size, in a predetermined manner, as the relative positioning between piston 1 and cylinder 2 changes. This in turn, establishes any designed pressure differential between piston 1 and cylinder 2, while simultaneously compensating for any auxiliary spring action that may be applied.

Turning to FIG. 3, if piston 1 moves near the lowest position possible into cylinder 2 during a compression stroke, as when the system might experience extreme acceleration forces during a heavy compression between the piston attachment means 12 and cylinder attachment means 13, custom shape 11 is designed so as to cause rod 4 to substantially obstruct the opening of valve orifice 14, thereby substantially eliminating the flow of fluid 16 between cylinder 2 and piston 1. Practically speaking, substantially eliminating the flow of fluid 16 between cylinder 2 and piston 1 thereby forms a hydraulic lock between piston area 5 and lower cylinder area 6. In other words, the hydraulic forces imposed by the closed pressure areas prevent piston 1 from further engaging into cylinder 2. This, in turn, translates to substantially preventing piston attachment means 12 from encroaching too close to cylinder attachment means 13, (in the application of a shock absorber, thereby preventing a “bottoming out” of the vehicle's suspension).

Returning to FIG. 1, when a downward accelerating force, (such as an expansion stroke), is applied to cylinder 2 causing it to move farther away from piston 1, a pressure differential is again created between the fluid 16 in lower cylinder area 6 and piston area 5 whereby fluid 16 flows into lower cylinder area 6 from piston area 5 through the opening of valve orifice 14. Simultaneously, due to the pressure differential, fluid 16 flows from upper cylinder area 9 toward the lower pressure in lower cylinder area 6 through fluid passage 8. Such flows of fluid 16 continues until the downward movement of cylinder 2 ceases and the relative pressures differentials between piston area 5, lower cylinder area 6 and upper cylinder area 9 dissipate. Such compression and expansion strokes are typically repeated numerous times in rapid succession during the performance of a shock absorber, strut or other motion restriction device.

Therefore, as detailed above, embodiments of the presently disclosed invention in the form of a motion restriction device, or more specifically a vehicle shock absorber, are capable of controlling both the upward and downward acceleration of cylinder 2 in relation to piston 1. By the means thus described, axle and wheel motion in a ground vehicle suspension system can be precisely controlled in both directions of movement with varying resistances at the ends of the suspension stroke.

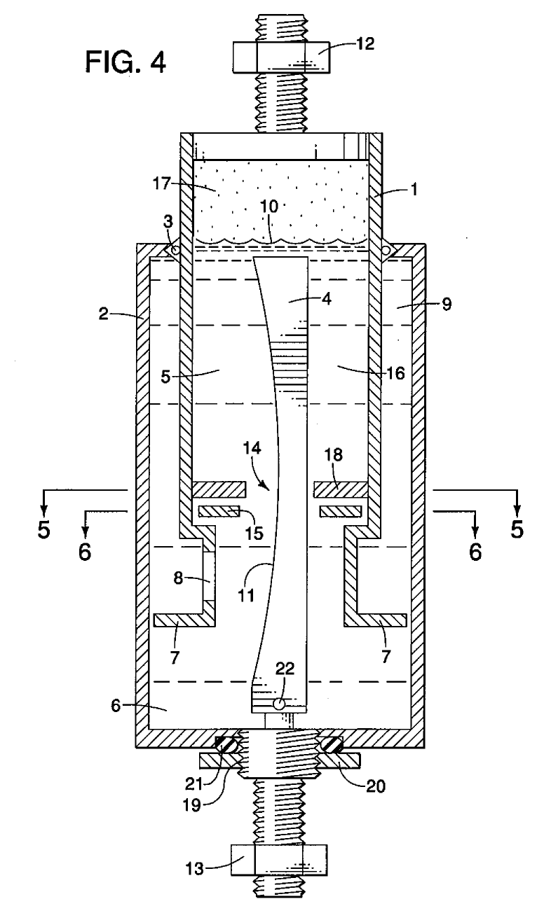

Turning to FIG. 4, an embodiment is illustrated possessing the desirable capabilities of disassembly and adjustability. As the vast majority of components and characteristics shown in this figure are similar to those shown in FIGS. 1 through 3, the principal focus of the following discussion shall be on contrasting the various components and characteristics from those in the embodiments depicted in FIGS. 1 through 3.

First, it can be noted that a valve wall containment flange 18, a disassembly threads 19, a disassembly lock washer 20, a disassembly seal 21 and a disassembly rod attachment means 22 are additional components or characteristics illustrated in FIG. 4 that are not illustrated in other embodiments shown in FIGS. 1 through 3. While it is not necessary to include all of these components or characteristics to practice an alternate embodiment that possesses the capability of being disassembled or adjusted, these components and characteristics represent a preferred embodiment of such an adjustable motion restriction device.

As depicted in FIG. 4, valve wall 15 is contained and sandwiched between valve wall containment flange 18 and a lower portion of piston 1 such as piston footing 7. Since the valve wall 15 enjoys some mobility in the space between valve wall containment flange 18 and piston footing 7, valve wall 15 can be rotated about its axis parallel to the axis of the piston 1. Because valve wall 15 can rotate, valve orifice 14 can align and follow any rotation of rod 4 that may occur during the disassembly process.

To disassemble and remove rod 4 from the motion restriction device shown, one skilled in the art would loosen and remove the cylinder attachment means 13 from the device by rotating the cylinder attachment means 13 with respect to cylinder 2. Since the cylinder attachment means 13 is connected to rod 4 by a disassembly rod attachment means 22, rod 4 necessarily rotates in conjunction with cylinder attachment means 13 if a threaded attachment means is implemented, further causing valve orifice 14 and valve wall 15 to rotate in conjunction with rod 4. Once the cylinder attachment means 13 and rod 4 have been removed from the device, it is possible to detach the rod 4 from the cylinder attachment means 13 using the disassembly rod attachment means 22. Disassembly rod attachment means 22 can be designed and fabricated as any connection between rod 4 and cylinder attachment means, such as a bolt or pin attachment, quick disconnect attachment, press fit, slotted or friction attachment, or other attachment means known to those skilled in the art.

It is also noted that while a threaded implementation of cylinder attachment means 13 is illustrated and detailed herein as a disassembly threads 19, embodiments of the present invention can also utilize other attachment means such as press fit, slotted or friction attachment, quick disconnect attachment or other attachment means known to those skilled in the art. The principal functions performed by cylinder attachment means 13 relate to securing rod 4 to cylinder 2, and further providing a means for the environment or physical structures to connect to cylinder 2.

With respect to the design and fabrication of cylinder attachment means 13 and cylinder 2, if using a threaded design is also preferable to configure a disassembly lock washer 20 and a disassembly seal 21 upon the device to ensure a leak proof communication of the cylinder attachment means 13 to cylinder 2 at the location of a disassembly threads 19.

As also illustrated, piston attachment means 12 and cylinder attachment means 13 can be attached to environmental or physical structures with a variety of attachment means known to those skilled in the art. As shown in FIG. 4, a threaded shaft with a nut is used in place of the eye hole designs of FIGS. 1 through 3. Such a piston attachment means 12 and cylinder attachment means 13 can be readily attached to a vehicle frame and vehicle axle, respectively.

After rod 4 is removed from the motion restriction device, rod 4 can conveniently be modified, substituted or simply replaced after completing all other desired maintenance of the internal chambers of the device, (e.g. a fluid check or fluid replenishment, etc.).

As noted earlier, rod 4 is preferably configured of a rectangular cross section. Such a component is easy to modify without the necessity of a lathe or special tool required for circular rods that may be present in other prior art devices.

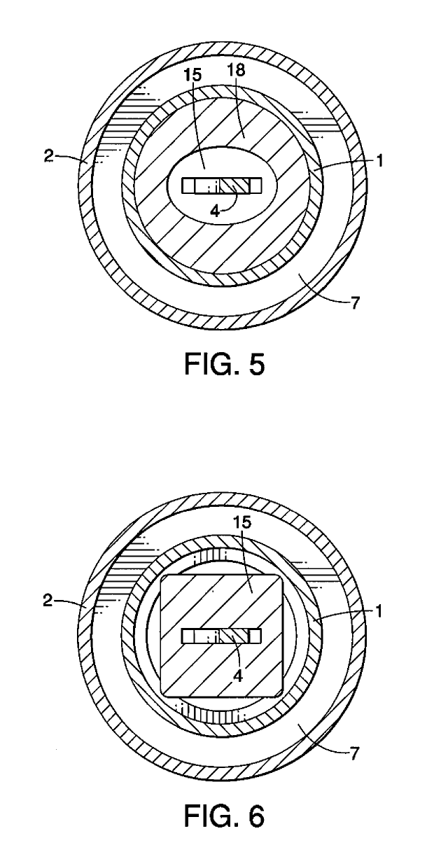

FIGS. 5 and 6 illustrate from different cut-away top views the relationships between a valve wall containment flange 18, a valve orifice 14, a valve wall 15, a rod 4, piston footing 7, a piston 1 and a cylinder 2 in an embodiment of the present invention. Namely, as earlier detailed, valve wall containment flange 18 functions to stabilize and hold valve wall 15 in a fixed position and prevent valve wall 15 from encroaching toward the closed end of the piston 1. Because valve wall 15 is not affixed to valve wall containment flange 18, valve wall 15 is free to rotate about its axis parallel to the axis of piston 1 for disassembly or adjustment.

Similarly, piston footing 7 functions to stabilize and hold valve wall 15 from encroaching upon the open end of piston 1, while allowing valve wall 15 to rotate about its axis parallel to the axis of piston 1 for disassembly or adjustment.

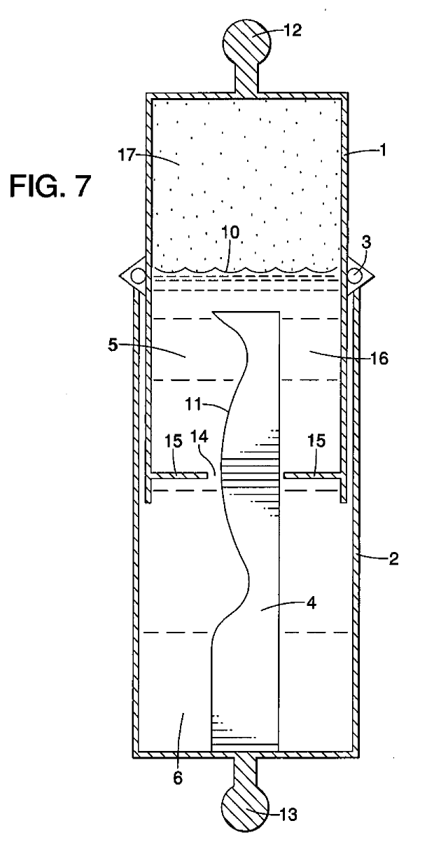

Turning to FIG. 7, another embodiment of the present invention is illustrated. In contrast to other embodiments illustrated in FIGS. 1 through 4, the embodiment of FIG. 7 demonstrates that embodiments of the the invention can be practiced without a piston footing 7, fluid passage 8 and upper cylinder area 9. As depicted, a lower cylinder area 6 encompasses substantially, if not all, the volume defined by the inner surfaces of cylinder 2.

The embodiment also demonstrates a rod 4 having a custom shape 11 that is substantially convex across its longitudinal axis. Such a custom shape 11 translates into a mechanical fluid flow control valve that aggressively restricts the flow of fluid 16 through the valve orifice 14 when the rod 4 is roughly midway through the valve orifice 14. If applied as a motion restriction device, this embodiment can be characterized as having an aggressive motion resistance in the center of its stroke, with a decreasing motion resistance as the middle of the rod 4 moves away from the valve orifice 14. It is also noted, that the opposing ends of the rod 4 have sharply accelerated large diameters to thereby create a hydraulic lock, such that the piston 1 will not: (i) become disengaged from cylinder 2 during an extreme extension stroke, nor (ii) become damaged by making physical contact with the closed end of cylinder 2 during an extreme compression stroke.

The embodiment depicted also illustrates yet another attachment means for piston attachment means 12 and cylinder attachment means 13 to the environment or other physical structures. As depicted, piston attachment means 12 and cylinder attachment means 13 can be characterized as a quick release attachment or alternatively as a “ball and socket” attachment to those skilled in the art.

In a practical application, the embodiment illustrated in FIG. 7 would be suitable as a motion restriction device or recoil absorber for an artillery device, such as a cannon. Depending upon the burn rate of the gunpowder or explosive materials used, such a artillery charge when fired can result in an initial increase of pressure, followed by a peak in the pressure, followed by a deterioration of pressure. As such, the embodiment shown can adapt to such a rising-peaking-falling pressure cycle while maintaining a constant relative motion between piston 1 and cylinder 2.

### Alternate Embodiments

There are a diversity of additional embodiments anticipated by the present invention, as further summarized below. It is understood that the mechanical fluid flow control valve disclosed herein provides a means of controlling the flow of a fluid supply between two or more areas (not necessarily between two or more enclosed chambers) to downstream processes or customers. Therefore, it is further understood that the following examples are not limiting by nature, but rather specific examples where the disclosed mechanical fluid flow control valve can be applied to solve a problem.

Embodiments of the present invention can be used in agricultural or municipal applications to control the pressure and flow of water. For example, it is typical for a large tank of water to be used to supply water for irrigation, public services or other purposes. It is further desirable for the flow of such water to be at a constant rate, despite the varying level of water in the tank from day to day. Under the present art, achieving a constant flow in gallons per minute (GPM) requires complicated valves that contain springs that must be calibrated. However, utilizing an embodiment of the present invention, one could configure a rod and orifice valve as disclosed with a custom shape to provide an increased effective valve orifice to increase fluid flow through the valve orifice when the pressure in the large tank is low. Conversely, when such a tank of water is full and the water pressure is increased, the rod would move the other direction with respect to the valve orifice, thereby reducing the effective valve orifice to counter the increased water pressure, resulting in the desired constant flow rate.

Embodiments of the present invention can also be utilized to improve seat technologies. By way of example, off-shore racing events and boats are often limited by the amount of damage that is afflicted to internal organs of a human being enduring such high-speed pounding of waves for extended hours. Such endeavors frequently cause kidney (and other) damage to occupants of such vehicles. However, seats utilizing a suspension that implements embodiments of the present invention permit the boat designer or occupant to configure a seat to have desirable motion resistance characteristics that are presently not achievable under the present art.

### EXAMPLES

In a recent experiment conducted by the inventors in Barstow, Calif., U.S.A., several embodiments of the present invention, (hereinafter the “new shock absorbers”), were compared against well-known expensive racing shock absorbers, (hereinafter referred to as the “control shock absorbers”), which are presently marketed by a leading manufacturer.

The physical dimensions of the shock absorbers were identical at 14 inches long with a 2.5 inch diameter. The control shock absorbers weighed 17 pounds each, plus the additional weight of a nitrogen tank and hose. It was necessary for the nitrogen tank to be installed at an elevation above the control shock absorbers on the vehicle. By comparison, the new shock absorbers weighed only 10 pounds and did not require any special installation considerations.

Following each vehicle's run of the course, the temperature of both sets of shock absorbers were taken by a laser thermometer and recorded. In sum, the control shock absorbers averaged a temperature of 160 degrees Fahrenheit, plus or minus roughly 5 degrees per shock absorber. By comparison, the new shock absorbers averaged a temperature of 110 degrees Fahrenheit, plus or minus roughly 5 degrees per shock absorber.

As can be readily ascertained from the above data, embodiments of the present invention demonstrated significantly less heat generation, while providing a simpler and lighter installation. By all comparative data points, embodiments of the present invention outperformed the best technology available under the present art.

### Conclusion

The novel approaches described herein for controlling the flow of fluid between two fluid pressure areas in a fluid system, and for controlling the motion of two fluid pressure areas and their attached physical structures, provide several advantages over prior approaches.

Embodiments of the present invention configured by a custom shape of the rod and orifice provide for less motion restriction in the mid-stroke region than traditional automotive shock absorbers. Conventional shock absorbers do not have the degree of programmability afforded by the rod and orifice design. Due to this lack of programmability for various resistances, traditional clapper valve shocks must make a trade-off between motion resistance in the mid-stroke region versus the extreme extension regions, with the result that a compromise of motion resistance is selected. Too much motion resistance in the mid-stroke region, where most of the shock absorber's time is spent, results in excess energy absorption by the traditional shock absorber, creating excess, unnecessary, and undesirable heat generation, excess tire sidewall flex, excess tire heat, excess tire wear, uneven force variations between the tire and the road—and a bumpier ride.

In addition to the above, traditional shock absorber's must compromise motion resistance when in the extreme extension and compression positions, resulting in the undesirable conditions of extreme strokes of the suspension in either compression or extension.

Embodiments of the present invention, specifically motion restriction devices and shock absorbers, eliminate such a compromise as the device can be programmed via the rod and orifice to provide for low motion restriction in the mid-region positions while preserving a desirable highly motion restricted response in the extreme extension and compression positions. The result of such a custom shape of the rod and orifice is a smoother ride in the mid-stroke (normal) use with less heat build-up, less tire wear, and more consistent contact and force between the tire and the road.

In certain specific applications such as off-road vehicles and racing, embodiments of the present invention improve safety through improved wheel contact with the ground. This performance improvement also results in higher average speeds over rough terrain.

On heavy trucks, such improved wheel contact with the ground and less absorption of energy is markedly pronounced in the benefits of increased mileage and reduced tire wear. More particularly, shock absorbers which offer less resistance in the normal compression stroke result in proportionately less sidewall flex of the tires. Because sidewall flex of the tires necessarily causes a waste of energy to the forward motion of a heavy truck into the tires, trucks fitted with embodiments of the present invention will waste less energy and enjoy improved life of the tires due to the reduced sidewall flex.

In the foregoing specification, the invention has been described as applicable to an automotive application, where the special advantages of the apparatus are very desirable. However the same invention may be applied to other mechanical objects or devices requiring a motion restriction device or motion restriction function to be performed.

Unless otherwise indicated, all numbers expressing quantities of ingredients, properties such as molecular weight, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, if any numerous references have been made to patents and printed publications throughout this specification, then each of the above cited references and printed publications, if any, are herein individually incorporated by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A mechanical fluid flow control valve for controlling fluid flow between two or more fluid pressure areas, comprising:
a piston of cylindrical shape having an open end and a closed end;
a cylinder of cylindrical shape having an open end and a closed end, wherein the open end of the piston is slidably engaged into the open end of the cylinder;
a piston area defined by inner surfaces of the piston;
a lower cylinder area defined by inner surfaces of the cylinder;
a valve orifice configured on the open end of the piston and defined by the piston, the valve orifice providing environmental communication between the piston area and the lower cylinder area;
a fluid occupying the lower cylinder area and a portion of the piston area, wherein the fluid can flow between the piston area and the lower cylinder area through the valve orifice;
a rod, having a first end and a second end, wherein the first end of the rod is connected to the closed end of the cylinder, wherein the rod passes through the valve orifice and wherein the first end of the rod is present in the piston area; and,
wherein the piston can slidably move back and forth inside the cylinder, such that the rod connected to the cylinder correspondingly moves back and forth inside the valve orifice, thereby controlling the fluid flow through the valve orifice.

2. The mechanical fluid flow control valve device of claim 1, wherein the piston is a consistent diameter, thereby creating a circular cross section.

3. The mechanical fluid flow control valve device of claim 1, wherein the piston comprises a rectangular cross section.

4. The mechanical fluid flow control valve of claim 1, wherein the cylinder is a consistent diameter, thereby creating a circular cross section.

5. The mechanical fluid flow control valve device of claim 1, wherein the cylinder comprises a rectangular cross section.

6. The mechanical fluid flow control valve of claim 1, wherein the cross section of the rod is rectangular.

7. The mechanical fluid flow control valve of claim 1, wherein the valve orifice is rectangular.

8. The mechanical fluid flow control valve of claim 1, wherein the fluid is of gaseous form.

9. The mechanical fluid flow control valve of claim 1, wherein the fluid extends upward into the piston area to a fluid level, wherein the fluid level is situated above the valve orifice.

10. The mechanical fluid flow control valve of claim 1, wherein the rod is configured in a custom shape, thereby controlling in a desirable manner the relative pressures between the piston area and the lower cylinder area.

11. The mechanical fluid flow control valve of claim 1, wherein the rod is configured in a custom shape, thereby controlling in a desirable manner the relative motion between the piston and the cylinder.

12. The mechanical fluid flow control valve of claim 11, wherein the custom shape of the rod is of varying cross section along its length, such that the first end and the second end of the rod are of greater diameter than the middle of the rod.

13. The mechanical fluid flow control valve of claim 1, further comprising a valve wall on the open end of the piston, wherein the valve wall defines the valve orifice.

14. The mechanical fluid flow control valve of claim 1, further comprising a cylinder fluid seal preventing leakage of the fluid between outer surfaces of the piston and inner surfaces of the cylinder.

15. The mechanical fluid flow control valve of claim 1, further comprising a gas occupying the piston area not otherwise occupied by the fluid.

16. The mechanical fluid flow control valve of claim 1, further comprising a piston attachment means connecting the piston to a first physical structure, and a cylinder attachment means connecting the cylinder to a second physical structure.

17. The mechanical fluid flow control valve of claim 1, further comprising:
a piston footing preventing the piston from becoming dislodged from the cylinder; and,
an upper cylinder area defined by inner surfaces of the cylinder and outer surfaces of the piston.

18. The mechanical fluid flow control valve of claim 17, further comprising a fluid passage defined by the piston footing, the fluid passage providing environmental communication between the lower cylinder area and the upper cylinder area.

19. The mechanical fluid flow control valve of claim 1, wherein the rod can be removed from the device.

20. A rod for a mechanical fluid flow control valve, the rod having a rectangular cross section, and wherein the mechanical valve comprises:
a piston of cylindrical shape having an open end and a closed end;
a cylinder of cylindrical shape having an open end and a closed end, wherein the open end of the piston is slidably engaged into the open end of the cylinder;
a piston area defined by inner surfaces of the piston;
a lower cylinder area defined by inner surfaces of the cylinder;
a valve orifice of rectangular shape and configured on the open end of the piston and defined by the piston, the valve orifice providing environmental communication between the piston area and the lower cylinder area;
a fluid occupying at least a portion of the lower cylinder area and at least a portion of the piston area, wherein the fluid can flow between the piston area and the lower cylinder area;
wherein the rod occupies a portion of the piston area and passes through the valve orifice; and,
wherein the piston can slidably move back and forth inside the cylinder, such that the rod correspondingly moves back and forth inside the valve orifice, thereby controlling the fluid flow through the valve orifice.

21. The rod for a mechanical fluid flow control valve of claim 20, wherein the rod can be removed from the mechanical fluid flow control valve.

22. A motion restriction device utilizing a mechanical fluid flow control valve for controlling motion between a first physical structure and a second physical structure, the device comprising:
a piston of substantially cylindrical shape having an open end and a closed end, wherein the piston is a consistent diameter;
a cylinder having an open end and a closed end, wherein the open end of the piston is slidably engaged into the open end of the cylinder, wherein the cylinder is a consistent diameter;
a piston attachment means connecting the piston to the first physical structure, and a cylinder attachment means connecting the cylinder to the second physical structure;
a piston area defined by inner surfaces of the piston;
a lower cylinder area defined by inner surfaces of the cylinder and the bottom surfaces of the piston;
an upper cylinder area defined by inner surfaces of the cylinder and outer surfaces of the piston, wherein the upper cylinder area is in environmental communication with the lower cylinder area;
a piston footing thereby defining a fluid passage, the fluid passage providing the environmental communication between the lower cylinder area and the upper cylinder area;
a valve wall on the open end of the piston, the valve wall defining a valve orifice, wherein the valve orifice configured on the open end of the piston and defined by the piston, the valve orifice providing environmental communication between the piston area and the lower cylinder area;
a fluid occupying the lower cylinder area, the upper cylinder area and a portion of the piston area, wherein the fluid can flow between the piston area and the lower cylinder area through the valve orifice, and the fluid can flow between the lower cylinder area and the upper cylinder area through the fluid passage, and further wherein the fluid extends upward into the piston area to a fluid level, wherein the fluid level is situated above the valve orifice;
a gas occupying the piston area not otherwise occupied by the fluid;
a cylinder fluid seal preventing leakage of the fluid between outer surfaces of the piston and inner surfaces of the cylinder;
a rod configured in a custom shape, having a first end and a second end, wherein the first end of the rod is connected to the closed end of the cylinder, wherein the rod passes through the valve orifice and wherein the first end of the rod is present in the piston area;
wherein the piston can slidably move back and forth inside the cylinder, such that the rod connected to the cylinder correspondingly moves back and forth inside the valve orifice; and,
wherein the custom shape of the rod thereby controls the relative pressure differences between the piston area and the lower cylinder area by changing the effective opening in the valve orifice, thereby controlling motion between the piston and the cylinder.
